(19) United States
(12) Patent Application Publication
(10) Pub. No.: US 2009/0035742 A1
(43) Pub. Date: Feb. 5, 2009

(54) ATOM MODELING KIT

(76) Inventor: Kenneth D. SNELSON, New York, NY (US)

Correspondence Address: WINSTON & STRAWN LLP;PATENT DEPARTMENT, 1700 K STREET, N.W., WASHINGTON, DC, 20006, US

(21) Appl. No.: 11/831,251

(22) Filed: Jul. 31, 2007

(51) Int. Cl. G09B 23/26

(52) U.S. Cl. 434/277

(57) ABSTRACT

A construction kit such as for the depiction of atoms and their electron arrangements in elements and compounds. This kit comprises a plurality of ring components each having plural connection points for connection to other ring components. The connection points typically comprise male connectors or female connectors with each ring component including one or more male connectors, one or more female connectors, or both male and female connectors, so that multiple ring components can be connected in different configurations to form three-dimensional objects in the form of hemispheres or spheres.

### BACKGROUND

The invention relates to a classroom science model and play set for demonstrating the organization of electrons in atoms.

In school science classes at all grade levels students are taught the basic principles of atomic structure: that atoms are composed of a tiny, heavy, nucleus around which very lightweight electrons are circulating in some unexplained manner. Students are further taught about the periodic table of chemical elements which keeps count of, and lists in sequence, the names of all chemical elements. Counting through the periodic table from Hydrogen, element number one, each successive type of atom has in its nucleus a number of protons with positive electrical charge equal to its atomic number. Surrounding the nucleus are an equal number of electrons.

Each electron in an atom is assigned a set of labels which define its position or energy level in the atom. The labels, four for each electron, known as “quantum numbers”, have been likened to theater seat assignments, one attendee to a seat. In the same way, no two electrons in an atom can have the same set quantum numbers. The student is instructed that the quantum numbers place each electron in a “shell” surrounding the nucleus like layers of an onion. Electron-by-electron, the shells become filled through a build-up or “aufbau” sequence element-to-element according to each one's atomic number. For example, two electrons completely fill up shell number one, the shell closest to the nucleus; 8 electrons fill up the next larger shell (number 2), 18 in the third shell, 32 in the fourth shell; again 32 in the fifth shell. In the final (synthetic) element, 103, Lawrencium, its seven shells are listed to contain, 2, 8, 18, 32, 32, 9, 2 electrons.

In addition to the sequence of shells and their maximum allowed numbers of electrons, there are also “sub shells” that generally describe partially occupied shells. Shell number two is made up of two sub shells containing, respectively, 2 (s electrons) and 6 (p electrons) totaling 8 electrons for the whole shell. In bigger atoms, in shell number three, added to the 2 “s” electrons and the 6 “p” electrons, there is a “d” sub shell with 10 electrons to complete the shell. The fourth shell can have additionally, 14 “f” electrons.

The standard textbook visualization of an atom with many-electrons is a flat drawing with a set of concentric circles representing the electron shells. Dots arranged around the rings represent the individual electrons. While such a diagram serves as a reasonable schematic, it offers the student zero spatial understanding about a three-dimensional atom. It is especially unsatisfactory in that it reinforces the long rejected conception of atomic electrons as tiny comets flying around the nucleus rather than understanding them as electron matter-waves, the founding conception of the standard Schrödinger wave model.

My previous patents, U.S. Pat. No. 3,276,148 “Model For Atomic Forms”, issued Oct. 4, 1966; and U.S. Pat. No. 4,099,339; “Model For Atomic Forms”, issued Jul. 11, 1978 describe the magnetic spatial relationships between atomic electrons in the geometry of circlespheres, i.e., symmetrical patterns of small circles on spheres. Models based on shells of magnets are excellent for representing individual shells but for concentric shells within shells, the manufacturing costs are prohibitive for casual classroom use.

Thus, there is a need for improved atom modeling sets for introduction to students in their beginning studies, so that they can fix the image of atoms as three dimensional entities; and with atomic electrons understood as matter waves and not as flying particles within the atom. The present invention now satisfies these needs.

### SUMMARY OF THE INVENTION

The present invention describes a simpler, more workable and attractive, device which overcomes the practical problems of a permanent magnet model. The invention adds new construction features for manufacturing an inexpensive and attractive classroom teaching device.

The invention relates to a construction kit such as for the depiction of atoms and their arrangements in elements and compounds. This kit comprises a plurality of ring components each having plural connection points for connection to other ring components. The connection points typically comprise male connectors or female connectors with each ring component including one or more male connectors, one or more female connectors, or both male and female connectors, so that multiple ring components can be connected in different configurations to form three-dimensional objects.

The kit generally includes 6 to 110 ring components and further comprises a stand component for engaging one or more of the ring components to support the three dimensional objects. The ring components of the kit are generally circular or oval. Some or all of the ring components may have a non-uniform body portion with increased dimensions at locations supporting the connection points. The most preferred connection points comprise tabs and grooves or snap locking members.

The invention also relates to a three dimensional object formed by connection of ring components from the kits described herein. These objects typically have a generally spherical shape termed circlespheres with a number of the ring components connected to other components at the connection points. A hemispherical shape is also desirable as an alternative. The components can be connected in a way which leaves openings between at least some adjacent ring components in either shape. Also, additional connected ring components can be present within the sphere or hemisphere as a second structure, and each structure can move or rotate independently of the other.

Thus, an atom modeling device comprising the kit disclosed herein and/or the objects disclosed herein represent additional embodiments of the invention.

### BRIEF DESCRIPTION OF THE DRAWINGS

FIG. 1 is a typical textbook schematic of an atom's electron shell structure.

FIG. 2 is an illustration of two ring components, one male and one female, according to the invention.

FIG. 3 is an illustration with a phantom detail of a final ring to be placed into a circlesphere according to the invention, indicating the temporary expansion of the space between the surrounding parts in order to insert the last ring into the shell.

FIG. 4 is an illustration of a fourteen ring circlesphere with checkerboard pattern and alternating male and female joining circles with final ring ready for insertion.

FIG. 5 is an illustration of a six ring circlesphere with “M” and “F” labels indicating for male and female joining elements alternating around each ring.

FIG. 6 is an illustration of six shells according to the invention in a broken view showing a partially completed assembly from shell one to shell six, all mounted on a supporting pedestal.

FIG. 7 is an illustration of a circlesphere representing a shell of 8 electron orbits.

FIG. 8 is an illustration of a circlesphere representing a shell of 10 electron orbits

FIG. 9 is an illustration of a circlesphere representing a shell of 14 electron orbits

FIG. 10 is an illustration of a circlesphere representing a shell of 18 electron orbits

FIG. 11 is an illustration of a circlesphere representing a shell of 32 electron orbits

FIG. 12 is an illustration of a pedestal stand having built-in ring members for holding and positioning five electron shells concentrically.

FIG. 12a is an exploded view of the pedestal stand of FIG. 12.

FIG. 13 is an illustration of an atom model according to the invention with pivoting axels connecting shells enabling each shell to revolve independently.

FIG. 14 is an illustration of a many-electron atom model with a five shells, all supported on a pedestal according to the invention.

### DETAILED DESCRIPTION OF THE PREFERRED EMBODIMENTS

In this invention each electron is represented as a wave-like small circle on a sphere. The ring-shaped orbitals made of plastic or other suitable material join with one another to form a spherical mosaic by means of tongue-in-groove or snap-fit joints which bind the entire shell firmly in place by means of a unique joining geometry. A spherical shell is formed by joining a set of orbitals which represents an atomic electron energy level with all electrons labeled and accounted for. The completed shells fit one inside another to represent a whole atom. The user may also construct a shell that is only partially filled. Finally, a display stand is shown that is able to hold the concentric spheres in position one to another. Another embodiment of the invention allows the separate spheres within spheres to revolve freely in the atom model.

The preferred features of my invention include:

An atom model constructed of plastic or other suitable material with parts that link together by means of a male/female joining system, taking advantage of the binary properties of select polyhedra.

A model of the atom's electron shells displayed in three dimensions rather than on a flat page.

An atom model capable of displaying, three-dimensionally, filled or partially filled shells and sub shells containing from 1 to 32 electrons.

A model whose electron orbitals are shaped like waves in order to develop understanding that atomic electrons form de Broglie standing waves.

An atom model of electron shells with each electron orbital labeled with its individual set of four quantum numbers.

A snap-in-place connecting principle that results in a firm spherical construction for each electron shell.

An atom model accompanied by a support-stand that interlocks with each shell and positions all shells centrally in relation to one-another and to the nucleus.

An atom model with spherical shells and sub shells able to revolve individually within the atom model.

An atom model with hemispherical shells and sub shells able to rotate independently.

Instructors of chemistry and physics must introduce the student to the concept of the atom as a heavy tiny nucleus surrounded by electrons. The challenge is to impart the idea that the atom is three-dimensional while the convention for presenting the atom's electron configuration customarily relies on a two-dimensional diagram as shown in FIG. 1, with concentric rings to represent the electron shells and dots distributed on the rings to indicate the numbers of electrons contained in the shell.

By contrast, the present invention is a simple and economical building set and classroom device for representing any atomic element's full electron configuration in a three-dimensional model as shown in FIGS. 13 and 14. A typical kit or set as described in the illustrations includes male and female joint, circle-shape, modules, with wave-like form as illustrated in FIG. 2. The modular parts are made of plastic or other suitable material. Specific numbers of these modules, depending upon which electron shell or energy level is to be constructed, are assembled to become an atom model comprising a set of spheres as illustrated separately in FIGS. 7, 8, 9, 10 and 11, and a pedestal stand as in FIGS. 12 and 12a.

Each construction item or module, as drawn in FIGS. 2a and 2b, represents a single atomic electron's wave-like orbit with either a male or a female joint capability. Taking advantage of the binary or checkerboard properties of the geometric circlesphere figures as illustrated in FIGS. 4, 7, 8, 9, 10, 11 of the invention wherein each part is either all male, FIG. 2a, or all female, FIG. 2b, tongue-in-groove, every module connects only with its opposite, male or female module. The wave-like shape of each module reinforces the conception of the electron's trajectory in the atom as a de Broglie standing wave of matter. The undulating shape also has the advantage, according to the invention, of offering the maximum material thickness for the joining elements at the tangential contact points where the modules connect to one another. During assembly the parts can be put together in only the correct way because exclusively male parts connect with exclusively female modules in the formation of a spherical shell. Not every circlesphere geometrical figure permits checkerboard alternation. The cubic set as illustrated in FIG. 5 requires some combination of hermaphrodite parts.

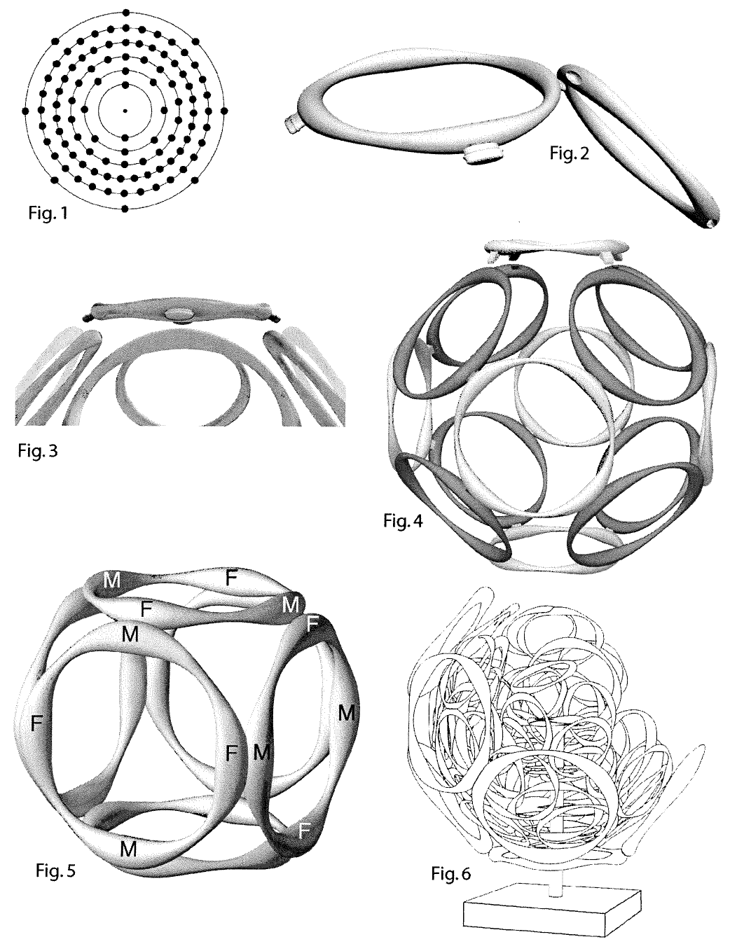

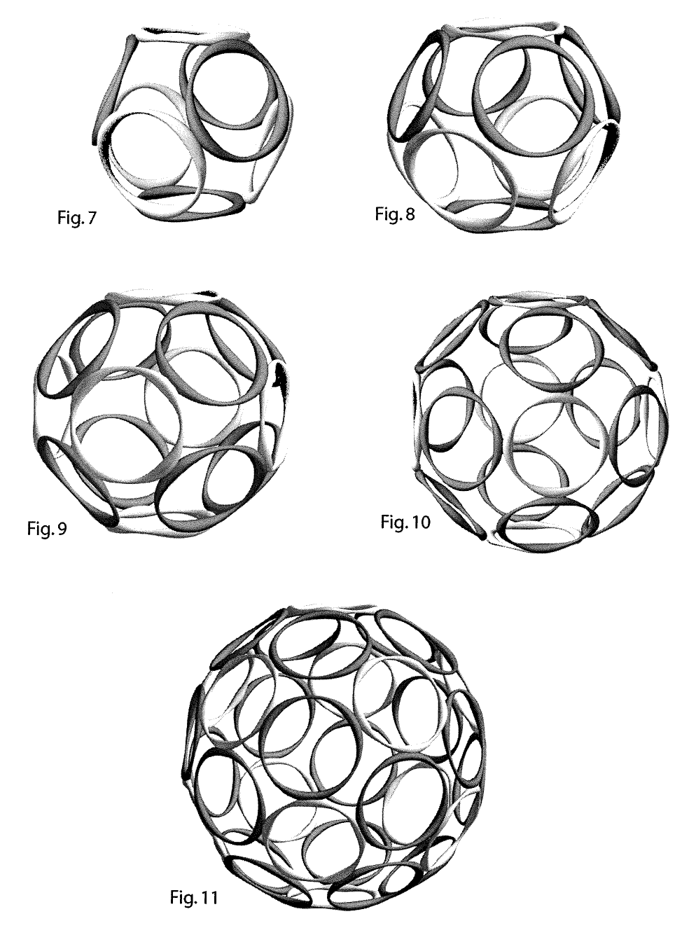

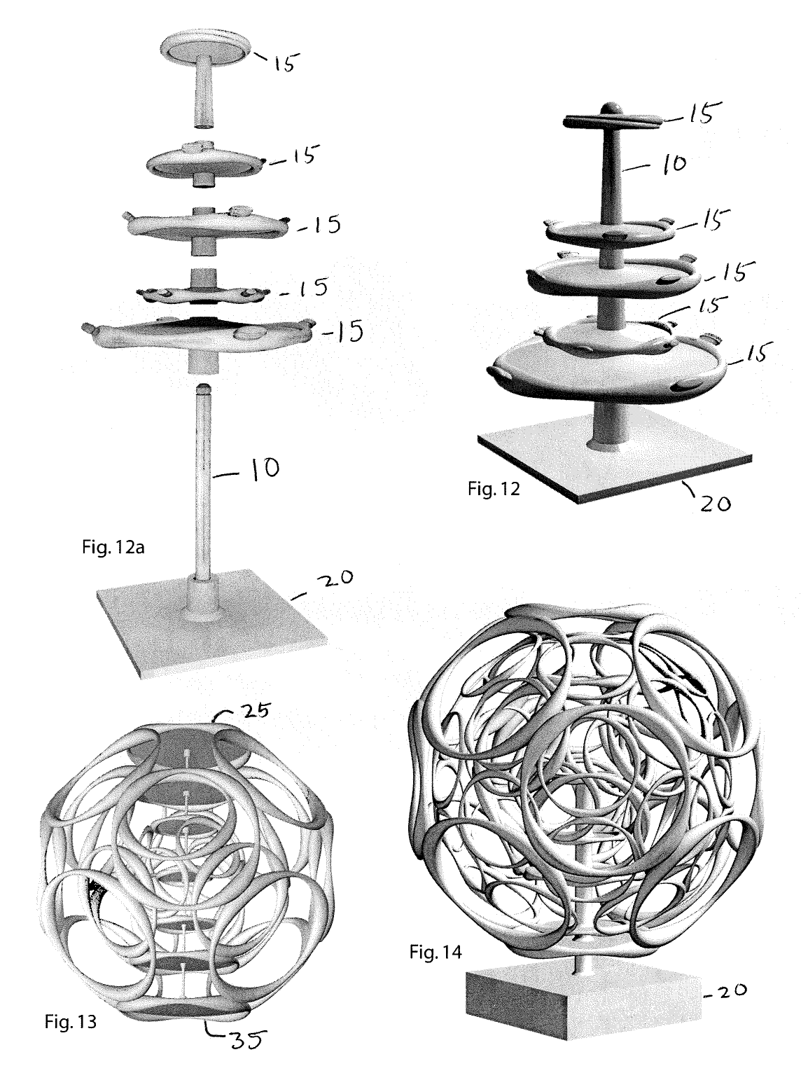

When the modules are joined to build shells, FIGS. 4, 7, 8, 9, 10, 11, the parts fit together in such a way that when the final module is inserted in the shell construction, the completed sphere becomes locked. This locking system is illustrated in FIGS. 3(3b and 3c), with a phantom drawing of the neighboring modules being spread apart in order to insert the final module. FIGS. 3a and 4a.

The electron parts may be given quantum number labels according to the building-up principle of the periodic table. During the model's construction, beginning with shell number one, nearest to the nucleus each larger shell is constructed surrounding the previous sphere so that finally the shells are a set of spheres-within-spheres. FIG. 6

If desired, the invention can be configured in the shape of a hemisphere or other partial sphere rather than as a full sphere. This discloses the arrangement of the atoms without completing the symmetry of the full sphere and allows other kit components to be available to form additional atomic models. For example, in FIG. 8, a ten ring model, the use of four rings (i.e., separation of the model at its equator) would result in two hemispheres.

In the preferred embodiment of the invention the pedestal stand, FIGS. 12 and 12a. This stand has an integrated column 10 and supporting base 20. The stand is an important part of the atom model kit because it provides a firm platform for the atom model, the pedestal stand is used as a starting point for the assembly of each shell. The pedestal, according to the invention has built into its central column 10, modules 15, for each of the shells-within-shells. To begin the assembly of each shell the column's corresponding module 15 is used as a base, a foundation on which to construct each concentric shell like adding branches to a tree. In sequence, the model is thus built up shell-by-shell outwardly from the core of the pedestal.

In a variation of the invention, FIG. 13, each of the shells has two special modules, one at the sphere's north pole 25 and one at its south pole, 35, each with a pivot pin extending outwardly to engage a female socket in the next larger shell's special north and south pole modules. This principle can be employed so that the spheres-within-spheres are gimbals enabling the shells to revolve independent of one another. When hemispheres are desired a shorter pedestal with only one pole is used and the “equator” of the hemisphere will rest on the base. The hemispheres can rotate independently of each other by the inclusion of the pivot pin at the north pole.

In either of these preferred embodiments of the invention, when construction of the atom model is completed, it becomes not only a valuable instrument for visualizing the atom with its electrons but also an attractive art work, bringing the satisfaction to the owner of having succeeded in creating a complex construction.

What is claimed is:

1. A construction kit comprising a plurality of ring components each having plural connection points for connection to other ring components, wherein the connection points comprise male connectors or female connectors and each ring component includes one or more male connectors, one or more female connectors, or both male and female connectors, so that multiple ring components can be connected in different configurations to form three-dimensional objects.

2. The kit of claim 1 that includes 6 to 110 ring components and further comprising a stand component for engaging one or more of the ring components to support the three dimensional objects.

3. The kit of claim 1 wherein some or all of the ring components have a non-uniform body portion with increased dimensions at locations supporting the connection points.

4. The kit of claim 1 wherein the connection points comprise tabs and grooves or snap locking members.

5. The kit of claim 1 wherein the ring components are generally circular or oval.

6. A three dimensional object formed by connection of ring components from the kit of claim 1.

7. The object of claim 1 wherein the object has a generally spherical or hemispherical shape with a number of the ring components connected to other components at the connection points.

8. The object of claim 7 wherein the components are connected in a way which leaves openings between at least some adjacent ring components.

9. The object of claim 7 which further comprises additional connected ring components present within the sphere or hemisphere.

10. The object of claim 7 which includes 6 to 110 ring components and further comprising a stand component for engaging one or more of the ring components to support the three dimensional object.

11. The object of claim 7 wherein some or all of the ring components have a non-uniform body portion with increased dimensions at locations supporting the connection points.

12. The object of claim 7 wherein the connection points comprise tabs and grooves or snap locking members.

13. The object of claim 7 wherein the ring components are generally circular or oval.

14. An atom modeling device comprising the kit of claim 1.

15. The device of claim 14 having the shape of a sphere

16. An atom modeling device comprising the object of claim 7.

17. The device of claim 17 having the shape of a sphere.
